(19) United States
(12) Patent Application Publication
(10) Pub. No.: US 2026/0181137 A1
(43) Pub. Date: Jun. 25, 2026

(54) METHOD AND APPARATUS FOR VIDEO CODING THAT ADAPTIVELY DETERMINES BLENDING AREA IN GEOMETRIC PARTITIONING MODE

(71) Applicants: Hyundai Motor Company, Seoul (KR); Kia Corporation, Seoul (KR); KWANGWOON UNIVERSITY INDUSTRY-ACADEMIC COLLABORATION FOUNDATION, Seoul (KR)

(72) Inventors: Dong Gyu SIM, Seoul (KR); Min Hun LEE, Uijeonbu-si, Gyeonggi-do (KR); Joo Hyung BYEON, Seoul (KR); Jin HEO, Yongin-si, Gyeonggi-do (KR); Seung Wook PARK, Yongin-si, Gyeonggi-do (KR)

(73) Assignees: Hyundai Motor Company, Seoul (KR); Kia Corporation, Seoul (KR); KWANGWOON UNIVERSITY INDUSTRY-ACADEMIC COLLABORATION FOUNDATION, Seoul (KR)

(21) Appl. No.: 19/125,115

(22) PCT Filed: Nov. 9, 2023
(86) PCT No.: PCT/KR2023/017993

§ 371 Date: Apr. 28, 2025

(30) Foreign Application Priority Data
Nov. 21, 2022 (KR) 10-2022-0156601
Nov. 8, 2023 (KR) 10-2023-0153800

(51) Int. Cl. H04N 19/119; H04N 19/593

(52) U.S. Cl. CPC H04N 19/119; H04N 19/593

(57) ABSTRACT

A method and an apparatus are disclosed for video coding that adaptively determine a blending region in a geometric partitioning mode. In the disclosed embodiments, a video decoding device decodes a geometric partitioning mode of the current block and partitions the current block into a first subregion and a second subregion centered on a geometric split boundary according to the geometric partitioning mode. The video decoding device generates first predicted signals for the first subregion and second predicted signals for the second subregion. The video decoding device determines a final blending region for weight summing the first predicted signals and the second predicted signals. The video decoding device determines a blending matrix and generates final predicted signals of the current block by weight summing the first predicted signals and the second predicted signals in the final blending region by using the blending matrix.

### TECHNICAL FIELD

The present disclosure relates to a video coding method and an apparatus that adaptively determine a blending region in a geometric partitioning mode.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

VVC technology employs geometric partitioning mode (GPM), an inter-prediction technology, for prediction based on flexible partitioning rather than square and rectangular partitioning based on Quadtree plus Multiple-type Tree (QT+MTT) partitioning structure. GPM performs the prediction of the current block based on a mode index and motion vector information for the partitioned region. Here, the mode index indicates one of the predefined geometric partitioning modes for partitioning the current block, and the motion vector information could be derived for predicting the subregion partitioned from the current block.

The encoder transmits the mode index and motion vector information to the decoder. The decoder partitions the current block into two regions according to the parsed geometric partitioning mode. The decoder uses the motion vector information to generate predicted signals for each subregion and then weight sums the generated predicted signals to generate the final prediction block. At this time, the weights used for weight summing may be determined based on the geometric partitioning mode, and a blending region may be determined to be a fixed region based on the size of the current block and the geometric partitioning mode. Because of the foregoing, to increase video coding efficiency and enhance video quality, there is a need for adaptively determining the blending region in the geometric partitioning mode.

### DISCLOSURE

### Technical Problem

The present disclosure seeks to provide a video coding method and an apparatus that generate prediction blocks of subblocks partitioned from a current block according to a geometric partitioning mode (GPM), and then adaptively determine a blending region for weight summing the prediction blocks of the subblocks.

### Technical Solution

At least one aspect of the present disclosure provides a method of reconstructing a current block by a video decoding apparatus. The method includes decoding a geometric partitioning mode of the current block. The method also includes partitioning the current block into a first subregion and a second subregion centered on a geometric split boundary according to the geometric partitioning mode. The method also includes generating first predicted signals for the first subregion and second predicted signals for the second subregion according to prediction modes of the first subregion and the second subregion. The method also includes determining a final blending region for weight summing the first predicted signals and the second predicted signals based on the first predicted signals, the second predicted signals, and an initial blending region. The method also includes determining a blending matrix in the final blending region. The method also includes generating final predicted signals of the current block by weight summing the first predicted signals and the second predicted signals in the final blending region by using the blending matrix.

Another aspect of the present disclosure provides a method of encoding a current block by a video encoding apparatus. The method includes determining a geometric partitioning mode of the current block. The method also includes partitioning the current block into a first subregion and a second subregion centered on a geometric split boundary according to the geometric partitioning mode. The method also includes generating first predicted signals for the first subregion and second predicted signals for the second subregion according to prediction modes of the first subregion and the second subregion. The method also includes determining a final blending region for weight summing the first predicted signals and the second predicted signals based on the first predicted signals, the second predicted signals, and an initial blending region. The method also includes determining a blending matrix in the final blending region. The method also includes generating first final predicted signals of the current block by weight summing the first predicted signals and the second predicted signals in the final blending region by using the blending matrix.

Yet another aspect of the present disclosure provides a computer-readable recording medium storing a bitstream generated by a video encoding method. The video encoding method includes determining a geometric partitioning mode of a current block. The video encoding method also includes partitioning the current block into a first subregion and a second subregion centered on a geometric split boundary according to the geometric partitioning mode. The video encoding method also includes generating first predicted signals for the first subregion and second predicted signals for the second subregion according to prediction modes of the first subregion and the second subregion. The video encoding method also includes determining a final blending region for weight summing the first predicted signals and the second predicted signals based on the first predicted signals, the second predicted signals, and an initial blending region. The video encoding method also includes determining a blending matrix in the final blending region. The video encoding method also includes generating final predicted signals of the current block by weight summing the first predicted signals and the second predicted signals in the final blending region by using the blending matrix.

### Advantageous Effects

As described above, the present disclosure provides a video coding method and an apparatus that generate prediction blocks of subblocks partitioned from a current block according to a geometric partitioning mode (GPM) and then adaptively determine a blending region for weight summing the prediction blocks of the subblocks. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a block diagram of a detailed portion of a video decoding apparatus according to at least one embodiment of the present disclosure.

FIG. 7 is a flowchart of a geometric partitioning mode according to at least one embodiment of the present disclosure.

FIG. 8 is a flowchart of a geometric partitioning mode according to another embodiment of the present disclosure.

FIG. 9 is a diagram illustrating an initial blending region according to at least one embodiment of the present disclosure.

FIG. 10 is a diagram illustrating a blending matrix according to at least one embodiment of the present disclosure.

FIGS. 11A and 11B are flowcharts of the determination of an implicit final blending region, according to some embodiments of the present disclosure.

FIGS. 12A to 12C are flowcharts illustrating the determination of strengths at geometric split boundaries, according to some embodiments of the present disclosure.

FIGS. 13A and 13B are diagrams illustrating the determination of strengths at geometric split boundaries, according to other embodiments of the present disclosure.

FIGS. 14A to 14D are diagrams illustrating the generation of a final blending region, according to some embodiments of the present disclosure.

FIG. 15 is a diagram illustrating the constitution of weights in the final blending region, according to at least one embodiment of the present disclosure.

FIG. 16 is a diagram illustrating the determination of a final blending region based on template matching, according to at least one embodiment of the present disclosure.

FIG. 17 is a flowchart of a method of encoding a current block by a video encoding apparatus, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

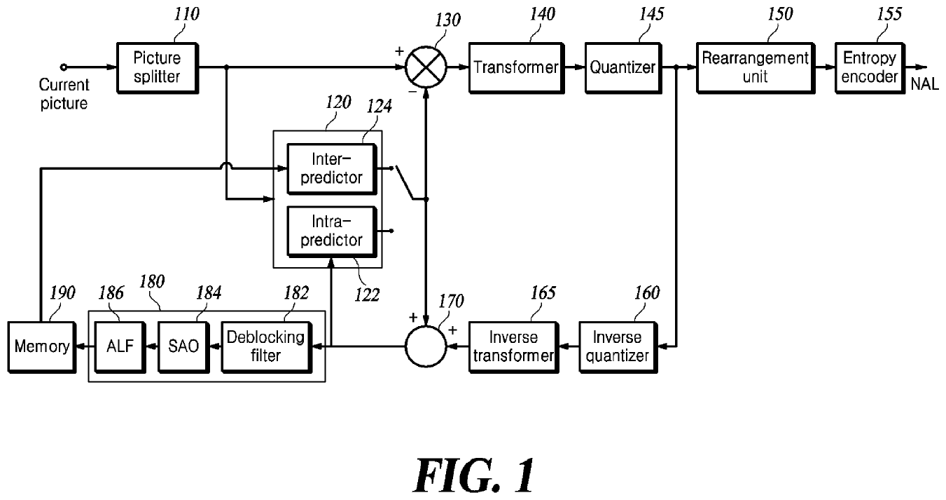

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

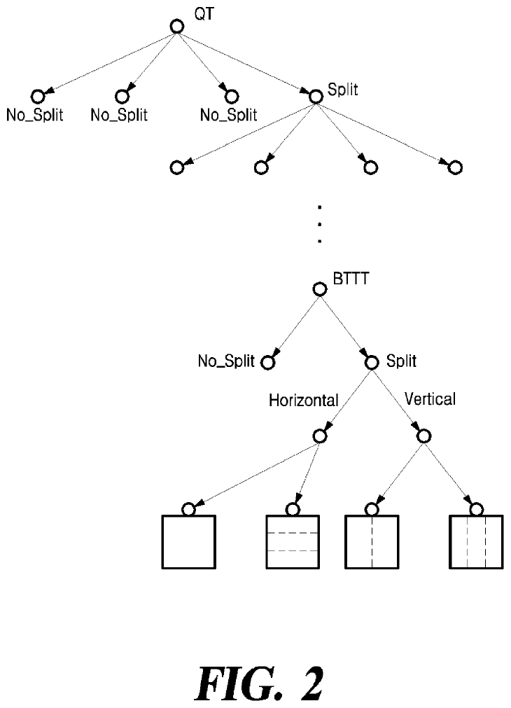

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

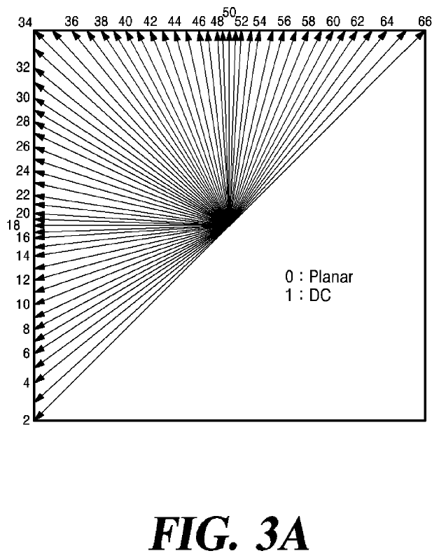

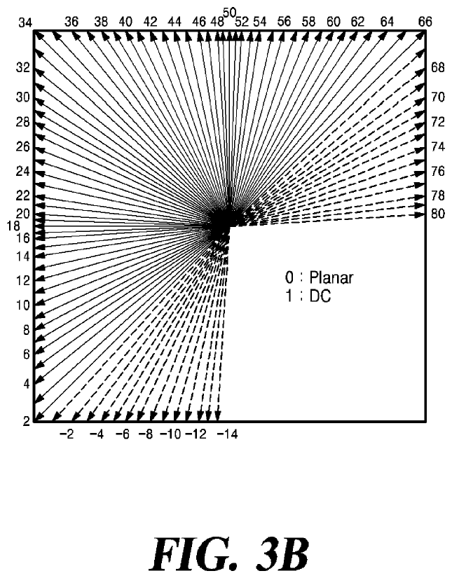

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #-1 to #-14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than-135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

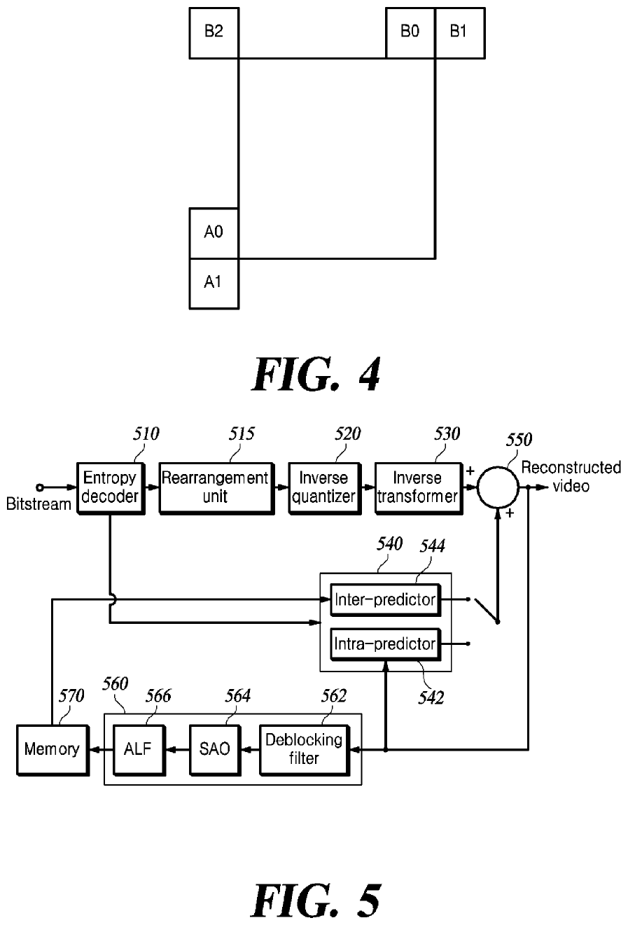

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a ID coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

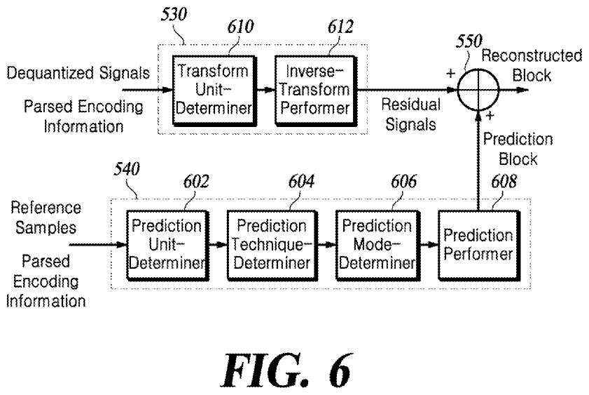

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform function or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus that generate prediction blocks of subblocks partitioned from the current block according to a geometric partitioning mode (GPM) and then adaptively determine a blending region for weight summing the prediction blocks of the subblocks.

The following embodiments may be performed by the predictor 120 in the video encoding device. The following embodiments may also be performed by the predictor 540 in the video decoding device.

The video encoding device in encoding the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

The following embodiments are described with respect to the video decoding apparatus, but they may be implemented in the same or similar manner in the video encoding apparatus.

FIG. 6 is a block diagram of a detailed portion of a video decoding apparatus according to at least one embodiment of the present disclosure.

The video decoding apparatus according to some embodiments can determine prediction unit and transform unit and with respect to a current block corresponding to the determined unit, perform a prediction and an inverse transform by using a determined prediction technique and prediction mode to finally generate a reconstructed block of the current block. The operations illustrated in FIG. 6 may be performed by an inverse transformer 530, a predictor 540, and an adder 550 of the video decoding apparatus. On the other hand, the same operations as illustrated in FIG. 6 may be performed by the inverse transformer 165, the picture splitter 110, the predictor 120, and the adder 170 of the video encoding apparatus. In this case, the video decoding apparatus uses encoding information parsed from the bitstream, but the video encoding apparatus may use encoding information set from a higher level in terms of minimizing rate distortion. Hereinafter, for convenience of description, the embodiments are described centering on the video decoding apparatus.

As illustrated in FIG. 5, the predictor 540 includes the intra predictor 542 and the inter predictor 544, depending on the prediction technique, but as illustrated in FIG. 6, the predictor 540 may include all or part of a prediction unit-determiner 602, a prediction technique-determiner 604, a prediction mode-determiner 606, and a prediction performer 608.

When the color format of the input video is a YUV format (YUV420, YUV411, YUV422, YUV444, and the like), the video decoding apparatus may perform prediction and reconstruction of the luma component and then may perform prediction and reconstruction of the chroma component. In other words, the luma component and the chroma component may be sequentially reconstructed by the components illustrated in FIG. 6. On the other hand, when the color format of the input video is RGB, the video encoding apparatus may perform a color format transform from RGB to YUV and then may encode the transformed video. Here, in the case of the YUV format, the color format represents a corresponding relation between pixels in the luma component and pixels in the chroma component.

The prediction unit-determiner 602 determines a prediction unit (PU). The prediction technique-determiner 604, with respect to the prediction unit, determines a prediction technique, e.g., intra prediction, inter prediction, or intra block copy (IBC) mode, palette mode, and the like. The prediction mode-determiner 606 determines a detailed prediction mode for the prediction technique. The prediction performer 608 generates a prediction block of the current block according to the determined prediction mode.

The inverse transformer 530 includes a transform unit-determiner 610 and an inverse transform-performer 612. The transform unit-determiner 610 determines a transform unit (TU) with respect to the inverse quantization signals of the current block, and the inverse transform-performer 612 inversely transforms the transform unit represented by the inverse quantization signals to generate residual signals.

The adder 550 sums the prediction block and the residual signals to generate a reconstructed block. The reconstructed block is stored in memory and may be used for predicting other blocks in the future.

The prediction unit determined by the prediction unit-determiner 602 may become the current block or one subblock of the subblocks split from the current block. In this case, the prediction unit of the chroma component may correspond in size to the prediction unit of the luma component, depending on the color format. Alternatively, the prediction units of the luma component and the chroma component may be determined separately, and the prediction may be performed for to the prediction unit of the chroma component.

The prediction technique-determiner 604 determines a prediction technique for the prediction units. As described above, the prediction technique may be one of inter prediction, intra prediction, IBC mode, and palette mode. In this case, the prediction technique of the chroma component may be determined to be the same as the prediction technique of the corresponding luma component without signaling and parsing separate information.

In one example, when the prediction technique of the current block is not intra prediction, the video decoding apparatus parses 1-bit flag information. For example, when the parsed flag indicates a skip mode, the video decoding apparatus determines that the prediction mode of the current block is a merge mode of inter prediction or an IBC merge mode. The video decoding apparatus may use the predicted signals as reconstructed signals, omitting the inverse transform process.

On the other hand, when the parsed flags do not indicate a skip mode for the current block, the prediction technique-determiner 604 may parse a series of one-bit flags to determine that the prediction technique of the current block is one of the techniques such as inter prediction, intra prediction, IBC mode, palette mode, or the like.

For example, when no skip is applied to the current block and the prediction technique is determined to be inter prediction or IBC mode, the video decoding apparatus parses a 1-bit flag. Depending on the parsed flag, the prediction mode of the current block may be determined as merge mode or advanced motion vector prediction (AMVP) mode.

The prediction mode-determiner 606 determines the prediction mode in detail for the prediction technique.

As an example, when the prediction technique is inter prediction, the prediction technique-determiner 604 may generate the final predicted signals of the current block as follows by parsing the 1-bit flag. For example, according to the geometric partitioning mode, the video decoding apparatus generates the predicted signals by using at least one motion compensation. The video decoding apparatus weight sums the multiple predicted signals to generate a prediction block, i.e., predicted signals or predictor of the current block.

As another example, when the prediction technique is intra prediction, the prediction technique-determiner 604 may generate the final predicted signals of the current block as follows by parsing the 1-bit flag. For example, according to the geometric partitioning mode, the video decoding apparatus generates the predicted signals by using a plurality of intra-prediction modes. The video decoding apparatus weight sums the multiple predicted signals to generate a prediction block of the current block.

The prediction performer 608 generates the prediction block of the current block according to the determined prediction technique and prediction mode.

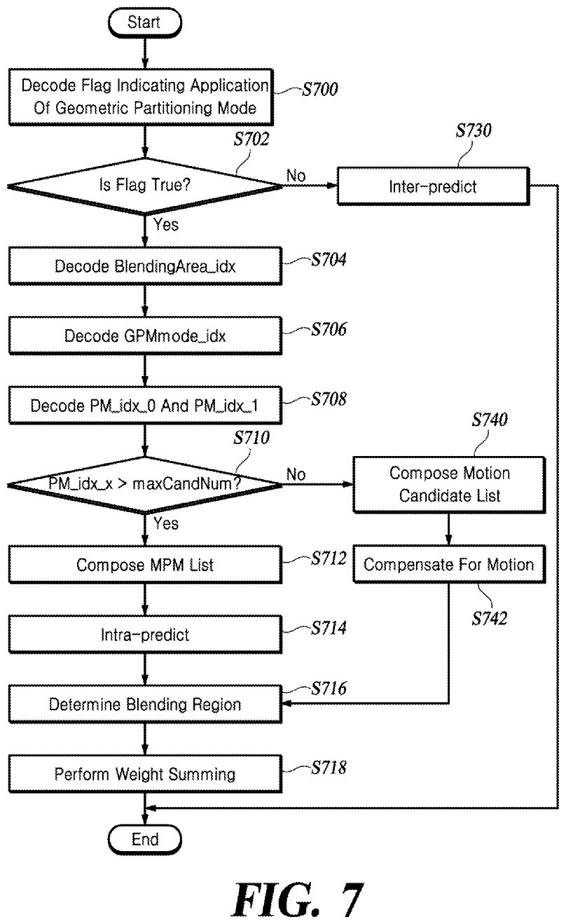

FIG. 7 is a flowchart of a geometric partitioning mode according to at least one embodiment of the present disclosure.

The example geometric partitioning mode in FIG. 7 illustrates a case where a final predicted signal is generated by weight summing two different predicted signals, including predicted signals generated according to at least one motion compensation. When the geometric partitioning mode is applied, the video decoding apparatus parses the information for predicting the current block, as illustrated in FIG. 7.

The video decoding apparatus decodes a flag indicating the application of the geometric partitioning mode (S700). The video decoding apparatus checks the aforementioned flag (S702).

If the flag indicating the application of the geometric partitioning mode is true (S702 Yes), the video decoding apparatus performs the following steps.

The video decoding apparatus decodes BlendingArea_idx, an index indicative of the size of the blending region (S704). In the example of FIG. 7, the step of parsing BlendingArea_idx may be omitted.

The video decoding apparatus decodes GPMmode_idx, which is an index indicating the geometric partitioning mode (S706).

For example, the geometric partitioning mode may be defined by using a look-up table (LUT) commonly between the video encoding apparatus and the video decoding apparatus. The video decoding apparatus may partition the current block into subregions according to the parsed index GPMmode_idx.

The video decoding apparatus decodes PredMode_idx_0 and PredMode_idx_1, which are indices representing the prediction mode of each subregion (S708). The video decoding apparatus generates a prediction block of each subregion as follows.

The video decoding apparatus determines whether or not PredMode_idx_x (x=0, 1) is greater than maxCandNum (S710). Here, maxCandNum is the maximum number of components of the motion candidate list. If PredMode_idx_x is greater than maxCandNum, then PredMode_idx_x indicates intra-prediction mode.

If PredMode_idx_x is greater than maxCandNum (Yes in S710), the video decoding apparatus uses intra prediction to perform the following steps for predicting the relevant subregion.

The video decoding apparatus composes a most probable mode (MPM) list by using the prediction information of the intra-prediction blocks within the neighboring reconstructed region of the current block (S712).

The video decoding apparatus intra-predicts the relevant subblock (S714).

The video decoding apparatus decodes the MPM index and derives from the MPM list the intra-prediction mode indicated by the MPM index. The video decoding apparatus generates predicted signals of the relevant subblock according to the derived intra-prediction mode.

As another example, the video decoding apparatus decodes the index that indicates the intra-prediction mode without composing the MPM list. According to the intra-prediction mode indicated by the index, the video decoding apparatus may generate predicted signals for the relevant subblock.

If PredMode_idx_x is less than or equal to maxCandNum (No in S710), the video decoding apparatus uses motion compensation to perform the following steps for predicting the relevant subregion.

The video decoding apparatus composes a motion candidate list (S740). The video decoding apparatus composes the motion candidate list by using the motion information in the neighboring reconstructed region of the current block.

The video decoding apparatus compensates for motion to inter-predict the relevant subblock (S742). The video decoding apparatus decodes an index indicating a candidate in the motion candidate list. The video decoding apparatus may use the motion information indicated by the decoded index to compensate for motion in the relevant subregion and thereby may generate predicted signals.

Upon generating the predicted signals for each of the subregions, the video decoding apparatus performs the following steps.

The video decoding apparatus determines a blending region (S716).

The video decoding apparatus performs weight summing on the blending region (S718). The video decoding apparatus performs the weight summing to generate the final predicted signals of the current block.

On the other hand, if the flag indicating the application of the geometric partitioning mode is false (S702 No), the video decoding apparatus performs inter prediction of the current block (S730).

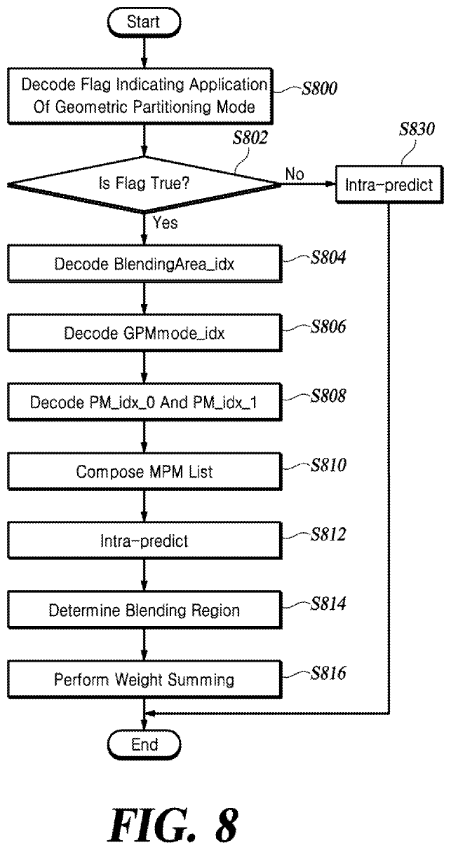

FIG. 8 is a flowchart of a geometric partitioning mode according to another embodiment of the present disclosure.

The example geometric partitioning mode in FIG. 8 illustrates a case where final predicted signals are generated by weight summing of two different predicted signals generated according to the intra prediction. When the geometric partitioning mode is applied, the video decoding apparatus parses information for predicting the current block, as illustrated in FIG. 8.

The video decoding apparatus decodes a flag indicating the application of the geometric partitioning mode (S800). The video decoding apparatus checks the aforementioned flag (S802).

If the flag indicating the application of the geometric partitioning mode is true (S802 Yes), the video decoding apparatus performs the following steps.

The video decoding apparatus decodes BlendingArea_idx, which indicates the size of the blending region (S804). In the example of FIG. 8, the step of parsing the BlendingArea_idx may be omitted.

The video decoding apparatus decodes GPMmode_idx, which is an index indicating the geometric partitioning mode (S806).

For example, the geometric partitioning mode may be defined by using a lookup table commonly between the video encoding apparatus and the video decoding apparatus. The video decoding apparatus partitions the current block into subregions according to the parsed index GPMmode_idx.

The video decoding apparatus decodes PredMode_idx_0 and PredMode_idx_1, which are indices representing the prediction mode of each subregion (S808). The video decoding apparatus generates an intra-prediction block for each subregion as follows.

The video decoding apparatus composes the MPM list by using the prediction information of the intra-prediction blocks within the neighboring reconstructed region of the current block (S810).

The video decoding apparatus intra-predicts the relevant subblock (S812).

The video decoding apparatus decodes the MPM index and derives from the MPM list the intra-prediction mode indicated by the MPM index. The video decoding apparatus generates predicted signals of the relevant subblock according to the derived intra-prediction mode.

As another example, the video decoding apparatus decodes the index that indicates the intra-prediction mode without composing the MPM list. According to the intra-prediction mode indicated by the index, the video decoding apparatus may generate predicted signals of the relevant subblock.

The video decoding apparatus determines a blending region (S814).

The video decoding apparatus performs weight summing on the blending region (S816). The video decoding apparatus performs the weight summing to generate the final predicted signals of the current block.

On the other hand, if the flag indicating the application of geometric partitioning mode is false (S802 No), the video decoding apparatus performs intra prediction of the current block (S830).

In the examples of FIG. 7 and FIG. 8, during the weight summing process for generating the final predicted signals, the blending region may be determined as follows.

In one example, based on the size of the current block and the geometric partitioning mode determined by GPMmode_idx, an initial blending region is determined to be a preset fixed area. In this case, as described above, in the examples of FIG. 7 or FIG. 8, the step of parsing BlendingArea_idx may be omitted.

As another example, the final blending region may be explicitly determined based on the BlendingArea_idx.

As yet another example, the final blending region may be implicitly determined by using a blending region determination process. In this case, as described above, in the examples of FIG. 7 or FIG. 8, the step of parsing BlendingArea_idx may be omitted.

The following describes in detail the determination of the blending region and the determination of the blending matrix.

In one example, the video decoding apparatus generates predicted signals for each of the subregions. For blending, the predicted signals for each subregion are generated for the entire region of the current block. The video decoding apparatus explicitly or implicitly determines a final blending region in the weight-summing process for generating the final predicted signals of the current block. Then, based on the determined final blending region, the video decoding apparatus calculates a blending matrix to be used in the weight-summing process.

For example, the video decoding apparatus calculates a blending matrix W_{B} based on the determined final blending region. In this case, each weight value W_{B}(i.j) in the blending matrix may be an integer value from 0 to 2ⁿ. Here, n is an integer greater than or equal to 0, which may be determined according to the size of the current block and/or the geometric partitioning mode. The geometric partitioning mode may be parsed or derived.

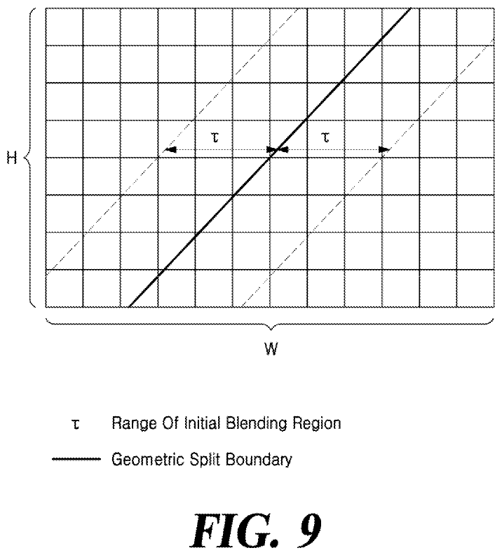

FIG. 9 is a diagram illustrating an initial blending region according to at least one embodiment of the present disclosure.

As another example, based on the size of the current block, geometric partitioning mode, and/or color components of the current block, the video decoding apparatus determines an initial blending region τ, as shown in FIG. 9.

In one example, the video decoding apparatus determines the initial blending region τ illustrated in FIG. 9 as the final blending region. In this case, the process of determining the blending region is omitted. Additionally, when the initial blending region is determined as the final blending region, the decoding process of BlendingArea_idx in the examples of FIG. 7 and FIG. 8 may be omitted.

In the example of FIG. 9, the current block is partitioned into a left (or upper) subregion and a right (or lower) subregion according to a geometric split boundary. Hereinafter, the two subregions are referred to as the first subregion and the second subregion, respectively. The predicted signals in the first subregion are denoted as P₀, and the predicted signals in the second subregion are denoted as P₁. As described above, for blending, the predicted signals of each subregion are generated for the entire area of the current block. The blending matrix is applied to the final blending region. In this case, the blending matrix W_{B} may be applied to P₀ and 1−W_{B} to P1, and vice versa. Hereinafter, P₀ may be used interchangeably with the first predicted signals and P₁ may be used interchangeably with the second predicted signals.

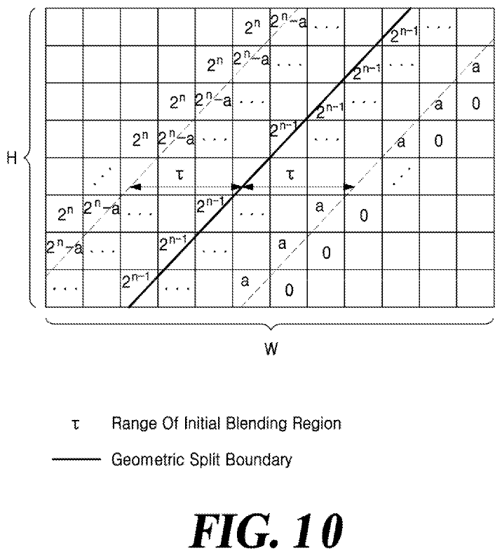

When the initial blending region τ is determined to be the final blending region, the video decoding apparatus determines the blending matrix W_{B} in the form of a weighting matrix, including gradually increasing and decreasing weights centered on the geometric split boundary, as illustrated in FIG. 10. In this case, the value ‘a’ may be an integer value determined based on the size of the current block, geometric partitioning mode, color component, and/or the final blending region.

In one example, based on the initial blending region τ illustrated in FIG. 9, the video decoding apparatus may determine a final blending region bτ. In this case, the value ‘b’ may be 2^{k} (where k is an integer). The video decoding apparatus may determine the final blending regions on both sides of the geometric split boundary as regions of different sizes. In this case, the range of ‘b’ values may be determined based on the current block's size, geometric partitioning mode, and/or color components.

Hereinafter, a blending region overlapping the first subregion centered on the geometric split boundary is denoted by τ₀, and a blending region overlapping the second subregion is denoted by τ₁.

In one example, the video decoding apparatus may implicitly determine the final blending region without decoding BlendingArea_idx as illustrated in FIG. 7 and FIG. 8.

As another example, the video decoding apparatus decodes a flag indicating whether the final blending region is to be implicitly determined on a per-CU basis. If the flag is true, the video decoding apparatus implicitly determines the final blending region of the current block and determines a corresponding blending matrix. On the other hand, if the aforementioned flag is false, the video decoding apparatus may, for example, determine the initial blending region as the final blending region as described above. Alternatively, the video decoding apparatus may perform decoding of BlendingArea_idx and determine the final blending region based on BlendingArea_idx.

The following describes methods of implicitly determining the final blending region and the blending matrix.

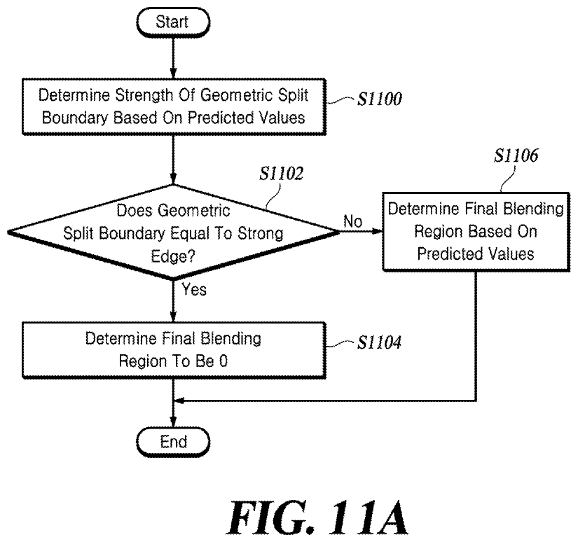

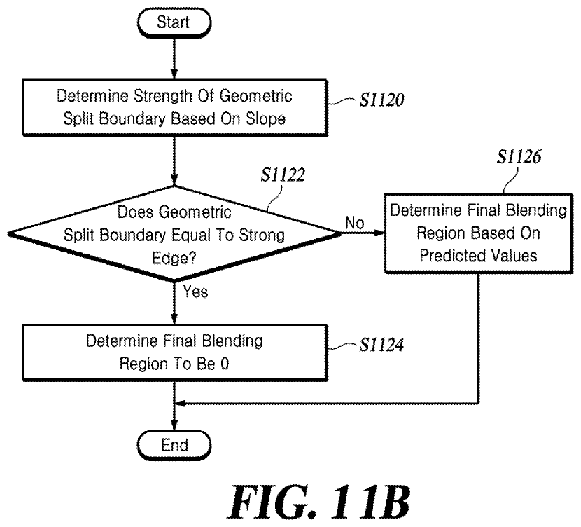

FIGS. 11A and 11B are flowcharts of the determinations of an implicit final blending region, according to some embodiments of the present disclosure.

Under the example of FIG. 11A, the video decoding apparatus determines the strength of the geometric split boundary based on predicted values and determines a final blending region based on the determined strength of the geometric split boundary.

The video decoding apparatus determines the strength of the geometric split boundary based on predicted values (S1100).

The video decoding apparatus determines if the geometric split boundary is a strong edge (S1102).

When the geometric split boundary is a strong edge (Yes in S1102), the video decoding apparatus sets the final blending region to 0 (S1104). Namely, the video decoding apparatus does not set the final blending regions τ0 and τ1. When the final blending regions τ0 and τ1 are determined to be 0, each weight of the blending matrix W_{B} is composed of 0 and 2^{k} centered on the geometric split boundary.

On the other hand, when the geometric split boundary is not a strong edge (No in S1102), the video decoding apparatus determines a final blending region based on the predicted values (S1106).

The following description describes detailed steps for determining the strength of the geometric split boundary based on the predicted values.

The video decoding apparatus may determine the strength S_{g} of the geometric split boundary by using the initial predicted signals P₀ and P₁ of the subregions. Here, the initial predicted signals P₀ and P₁ may be generated by using the initial blending regions τ₀ⁱ and τ₁ⁱ and the prediction modes PM_idx_0 and PM_idx_1 of the subregions.

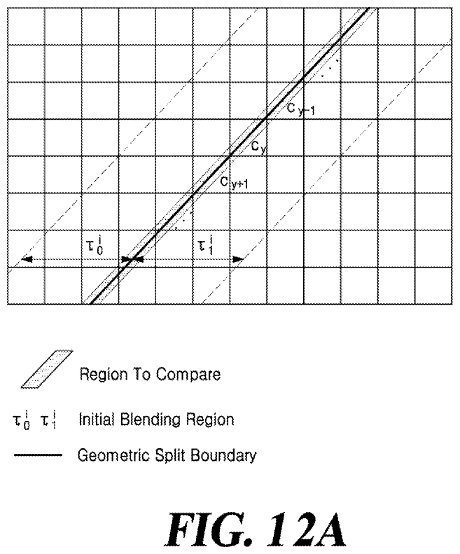

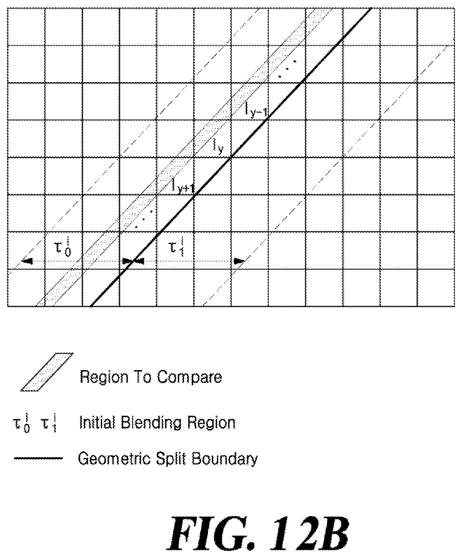

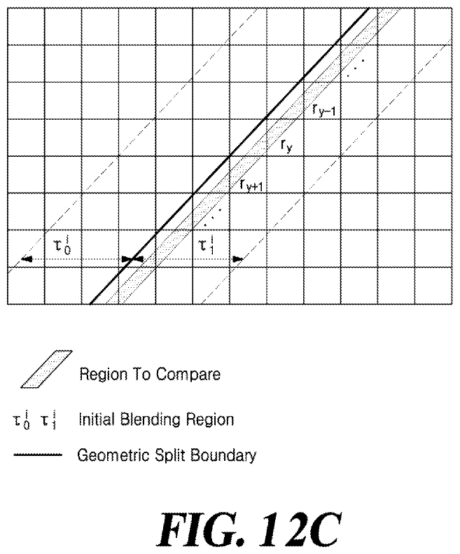

FIGS. 12A to 12C are flowcharts illustrating the determination of strengths at geometric split boundaries, according to some embodiments of the present disclosure.

By using the predicted signals of the two subregions centered on the geometric split boundary, the video decoding apparatus may calculate the strength at the geometric split boundary. The video decoding apparatus may determine the strength of the geometric split boundary by comparing the initial predicted signal values of a region adjacent to the geometric split boundary or an inner boundary parallel to the geometric split boundary, as illustrated in FIGS. 12A to 12C.

Meanwhile, the initial blending regions τ₀ⁱ and τ₁ⁱ on both sides of the geometric split boundary may be the same, as illustrated in FIGS. 12A to 12C. Further, the initial blending regions τ₀ⁱ and τ₁ⁱ on both sides of the geometric split boundary may be the same as the final blending regions τ₀ and τ₁ on both sides. The final blending regions τ₀ and τ₁ on both sides of the geometric split boundary may be different.

In one example, the video decoding apparatus determines the edge strength by comparing the sample values of the initial predicted signals P₀ and P₁ located at the geometric split boundary, as illustrated in FIG. 12A. The video decoding apparatus may determine the edge strength based on Equation 1 or Equation 2.

$$\vert {P}_{0} ( {c}_{y} ) - {P}_{1} ( {c}_{y} ) \vert < {th}_{c 1} \qquad [ Equation 1 ]$$

$${\sum }_{y} \vert {P}_{0} ( {c}_{y} ) - {P}_{1} ( {c}_{y} ) \vert < {th}_{c 2} \qquad [ Equation 2 ]$$

In Equation 1 and Equation 2, the thresholds th_{C1} and th_{C2} may be predetermined based on an arrangement between the video encoding apparatus and the video decoding apparatus. Alternatively, the thresholds may be signaled/parsed or determined based on the quantization parameters of the current block.

For each position, when there are ‘m’ or fewer cases satisfying Equation 1, i.e., when there are more than ‘m’ cases not satisfying Equation 1, the video decoding apparatus determines the geometric split boundary to be a strong edge. In this case, the threshold ‘m’ may be determined based on the size of the current block. Alternatively, if Equation 2 is not satisfied, the video decoding apparatus may determine the geometric split boundary to be a strong edge.

When the geometric split boundary is not determined to be a strong edge according to Equation 1 or Equation 2, the video decoding apparatus may determine the edge strength by comparing the initial predicted signal values in the region adjacent to the inner boundary parallel to the geometric split boundary, as illustrated in FIGS. 12B and 12C.

For example, by using the inner boundary present in the first subregion, i.e., to the left of the geometric split boundary, as illustrated in FIG. 12B, the video decoding apparatus may determine the edge strength according to Equation 3 or Equation 4.

$$\vert {P}_{0} ( {l}_{y} ) - {P}_{1} ( {l}_{y} ) \vert < {th}_{l 1} \qquad [ Equation 3 ]$$

$${\sum }_{y} \vert {P}_{0} ( {l}_{y} ) - {P}_{1} ( {l}_{y} ) \vert < {th}_{l 2} \qquad [ Equation 4 ]$$

In Equation 3 and Equation 4, the thresholds thₗ₁ and thₗ₂ may be predefined based on an arrangement between the video encoding apparatus and the video decoding apparatus. Alternatively, the thresholds may be signaled/parsed or determined based on the quantization parameters of the current block.

For each position, when there are ‘m’ or fewer cases satisfying Equation 3, i.e., when there are more than ‘m’ cases not satisfying Equation 3, the video decoding apparatus determines the geometric split boundary as a strong edge. In this case, the threshold ‘m’ may be determined based on the size of the current block. Alternatively, if Equation 4 is not satisfied, the video decoding apparatus may determine the geometric split boundary as a strong edge.

On the other hand, when there are ‘m’ or fewer cases satisfying Equation 3, i.e., when there are more than ‘m’ cases not satisfying Equation 3, the video decoding apparatus may determine the final blending region to of the first subregion to be 0. Alternatively, if Equation 4 is not satisfied, the video decoding apparatus may determine the final blending region to of the first subregion to be 0.

As another example, by using the inner boundary present in the second subregion, i.e., to the right of the geometric split boundary, as illustrated in FIG. 12C, the video decoding apparatus may determine the edge strength according to Equation 5 or Equation 6.

$$\vert {P}_{0} ( {r}_{y} ) - {P}_{1} ( {r}_{y} ) \vert < {th}_{r 1} \qquad [ Equation 5 ]$$

$${\sum }_{y} \vert {P}_{0} ( {r}_{y} ) - {P}_{1} ( {r}_{y} ) \vert < {th}_{r 2} \qquad [ Equation 6 ]$$

In Equation 5 and Equation 6, the thresholds thₗ₁ and thₗ₂ may be predefined based on an arrangement between the video encoding apparatus and the video decoding apparatus. Alternatively, the thresholds may be signaled/parsed or determined based on the quantization parameters of the current block.

For each location, when there are ‘m’ or fewer cases satisfying Equation 5, i.e., when there are more than ‘m’ cases not satisfying Equation 5, the geometric split boundary is determined to be a strong edge. In this case, the threshold ‘m’ may be determined based on the size of the current block. Alternatively, if Equation 6 is not satisfied, the video decoding apparatus may determine the geometric split boundary as a strong edge.

On the other hand, when there are ‘m’ or fewer cases satisfying Equation 5, i.e., when there are more than ‘m’ cases not satisfying Equation 5, the video decoding apparatus may determine the final blending region τ₁ of the second subregion to be 0. Alternatively, if Equation 6 is not satisfied, the video decoding apparatus may determine the final blending region τ₁ of the second subregion to be 0.

Alternatively, as in the example of FIG. 12A, when the geometric split boundary is classified as a strong edge based on predicted values at the geometric split boundary, the video decoding apparatus may further perform a process of determining the strength of the geometric split boundary based on a slope.

Under the example of FIG. 11B, the video decoding apparatus determines the strength of the geometric split boundary based on a slope and determines a final blending region based on the determined strength of the geometric split boundary.

The video decoding apparatus determines the strength at the geometric split boundary based on the slope (S1120).

The video decoding apparatus determines if the geometric split boundary is a strong edge (S1122).

When the geometric split boundary is a strong edge (Yes in S1122), the video decoding apparatus sets the final blending region to 0 (S1124). Namely, the video decoding apparatus sets the final blending regions τ₀ and τ₁ of the first subregion and the second subregion to 0. When the final blending regions τ₀ and τ₁ are determined to be 0, each weight of the blending matrix W_{B} is composed of 0 and 2^{k} centered on the geometric split boundary.

On the other hand, when the geometric split boundary is not a strong edge (No in S1122), the video decoding apparatus determines a final blending region based on the predicted values (S1126).

The following description describes detailed steps for determining the strength of the geometric split boundary based on the slope.

The video decoding apparatus may determine the slope-based strength S_{g} of the geometric split boundary by using the initial predicted signals P₀ and P₁ of the subregions. Here, the initial predicted signals P₀ and P₁ may be generated by using the prediction modes PM_idx_0 and PM_idx_1 of the subregions as described above. To calculate the slope, the video decoding apparatus utilizes the initial predicted signals within the initial blending region τ.

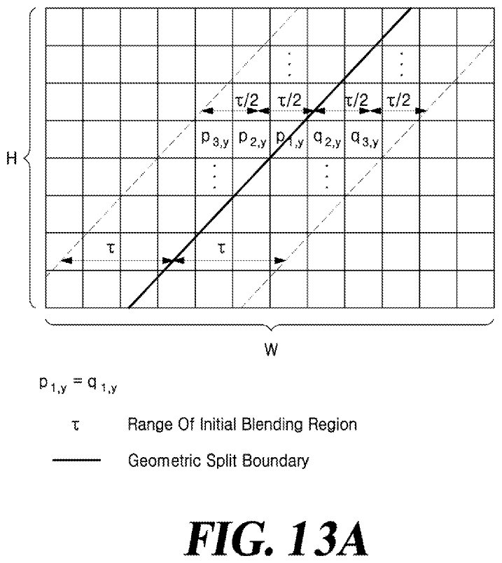

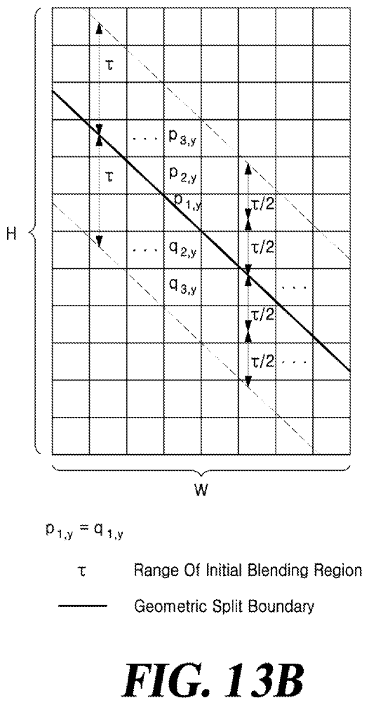

By using the predicted signals of the two subregions centered on the geometric split boundary, the video decoding apparatus may calculate the strength at the geometric split boundary. The video decoding apparatus may determine the strength S_{g} of the geometric split boundary by using the sum of slopes calculated according to FIG. 13A, FIG. 13B, and Equation 7.

$${S}_{g} = {\sum }_{y} ( \vert {P}_{0} ( {p}_{3 , y} ) - 2 \times {P}_{0} ( {p}_{2 , y} ) + {P}_{0} ( {p}_{1 , y} ) \vert + \vert {P}_{1} ( {q}_{3 , y} ) - 2 \times {P}_{1} ( {q}_{2 , y} ) + {P}_{1} ( {q}_{1 , y} ) \vert ) \qquad [ Equation 7 ]$$

After the strength of the geometric split boundary is calculated by using the sum of the slopes in the subregions according to Equation 7, the video decoding apparatus compares the strength of the geometric split boundary to a threshold. When the strength of the geometric split boundary is greater than or equal to the threshold, the video decoding apparatus sets the geometric split boundary to be a strong edge. In this case, the threshold may be predefined according to an agreement between the video encoding apparatus and the video decoding apparatus. Alternatively, the threshold may be signaled/parsed or determined based on the quantization parameters of the current block.

When the geometric split boundary is determined to be a strong edge, the video decoding apparatus may determine the final blending region to and τ₁ of the subregions to be 0.

As one example, in FIG. 13A, FIG. 13B, and Equation 7, the positions of p_{2,y} and q_{2,y} may be the intermediate position of p_{1,y} and p_{3,y}, and the intermediate position of q_{1,y} and q_{3,y}, respectively.

As another example, in FIG. 13A, FIG. 13B, and Equation 7, the positions of p_{2,y} and q_{2,y} may be those that are a sample distance τ/2 away from p_{1,y} and p_{3,y}, respectively. For example, if t is odd, the positions of p_{2,y} and q_{2,y} may be a sample distance round (τ/2) away from p_{1,y} and p_{3,y}, respectively. Alternatively, if t is odd, the positions of p_{2,y} and q_{2,y} may be the average of the samples at positions that are a sample distance round (τ/2) away from p_{1,y} and p_{3,y}, respectively, and the samples at positions that are a sample distance round (τ/2+0.5) away from p_{1,y} and p_{3,y}, respectively.

As another example, in FIG. 13A, FIG. 13B, and Equation 7, the samples at positions p_{2,y} and q_{2,y} may be those that are filtered from samples at positions that are τ/2 away from p_{1,y} and p_{3,y}, respectively. For the filtering, one of the filters may be used, such as a Gaussian filter, a smoothing filter, and the like.

The following description describes a detailed step (S1106 or S1126) of determining a final blending region based on the predicted values.

When the geometric split boundary is not determined to be a strong edge, the video decoding apparatus may generate the final blending regions τ₀ and τ₁ of the two subregions centered on the geometric split boundary, respectively. As described above, under the example of FIG. 12B or FIG. 12C, when the final blending region τ₀ of the first subregion or the final blending region τ₁ of the second subregion is determined to be 0, the video decoding apparatus generates only the final blending region of the remaining subregion.

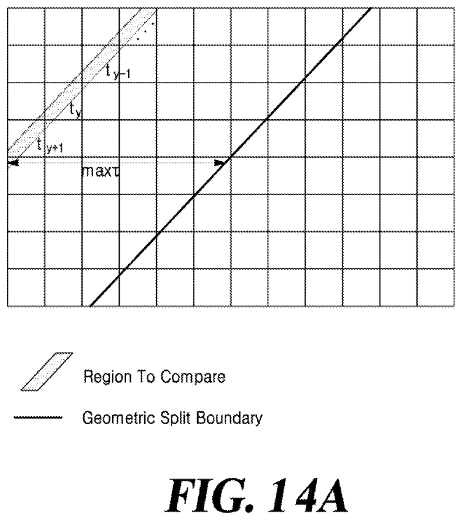

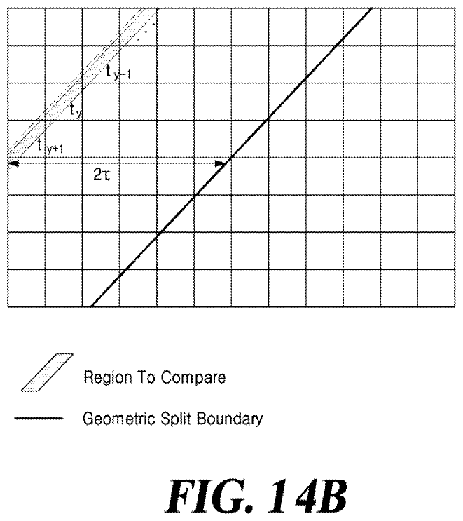

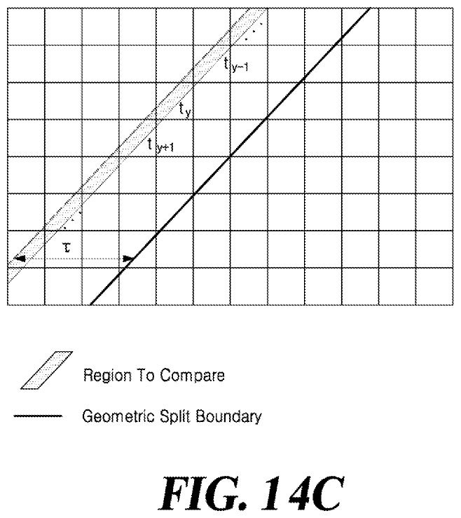

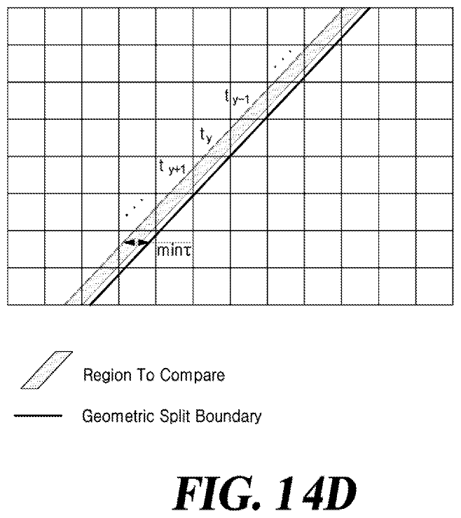

Hereinafter, a process for generating the final blending region to of the first subregion is described by using the examples of FIGS. 14A to 14D. The video decoding apparatus may generate the final blending region τ1 of the second subregion in the same manner as the example of FIG. 14.

FIGS. 14A to 14D are diagrams illustrating the generation of a final blending region, according to some embodiments of the present disclosure.

The video decoding apparatus sets an initial blending candidate region to be a maximum blending region maxτ applicable to the current block. The maximum blending region maxτ and the minimum blending region mint may be determined based on the current block's size, geometric partitioning mode, and/or color components. Alternatively, the maximum blending region maxτ may be explicitly determined based on the decoded BlendingArea_idx.

The video decoding apparatus may determine the final blending region according to Equation 8 and Equation 9, in a region distanced from the geometric split boundary by the blending candidate area.

$$\vert {P}_{0} ( {t}_{y} ) - {P}_{1} ( {t}_{y} ) \vert < {th}_{t 1} \qquad [ Equation 8 ]$$

$${\sum }_{y} \vert {P}_{0} ( {t}_{y} ) - {P}_{1} ( {t}_{y} ) \vert < {th}_{t 2} \qquad [ Equation 9 ]$$

In Equation 8 and Equation 9, the thresholds thₜ₁ and thₜ₂ may be predefined by an agreement between the video encoding apparatus and the video decoding apparatus. Alternatively, the thresholds may be signaled/parsed or determined based on the quantization parameters of the current block.

When there are ‘m’ or fewer cases satisfying Equation 8 for each position, the video decoding apparatus determines the current blending candidate region as the final blending region to. In this case, the threshold ‘m’ may be determined according to the size of the current block. Alternatively, if Equation 9 is satisfied, the video decoding apparatus may determine the current blending candidate region as the final blending region to.

If Equation 8 or Equation 9 is not satisfied, the video decoding apparatus may repeat the process described above by changing the candidate blending region. For example, the video decoding apparatus may reduce the candidate blending region to half of the previous region, as illustrated in FIGS. 14A to 14D.

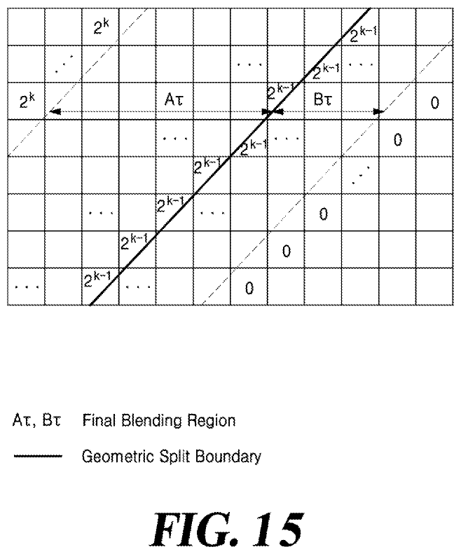

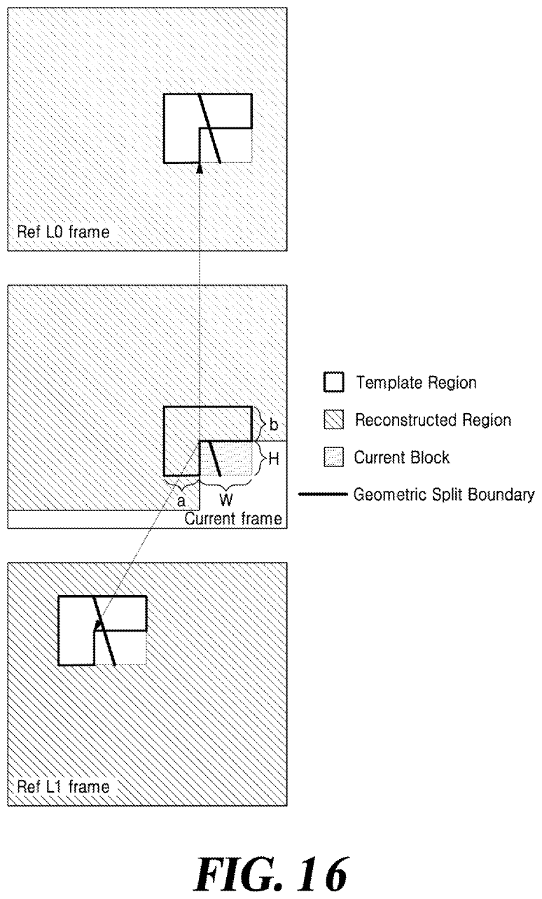

When the final blending regions τ₀ and τ₁ are determined as described above, the video decoding apparatus may determine the respective weights of the blending matrix W_{B} in each region centered on the geometric split boundary. For example, the video decoding apparatus may set a weight of 2^{k-1} in the region closest to the geometric split boundary and set weights of 2^{k} and 0 in the regions farthest from the geometric split boundary, respectively. When different blending regions are determined in the two subregions centered on the geometric split boundary, the video decoding apparatus may organize progressively decreasing weights, as illustrated in FIG. 15.

Meanwhile, the examples of FIGS. 14A to 14D and FIG. 15, Equation 8 and Equation 9, as described above, may be applied to both the left and right regions or the top and bottom regions centered on the geometric split boundary of the current block.

As another example, by using the index BlendingArea_idx decoded according to the examples of FIG. 7 and FIG. 8, the video decoding apparatus may explicitly determine the final blending region.

For example, the video decoding apparatus decodes an index of each of the blending regions τ₀ and τ₁ and determines the final blending region based on the decoded index. In this case, each blending region mapped to an index may be an integer multiple of the initial blending region illustrated in FIG. 9. Each blending region mapped to an index may contribute to the organization of a lookup table. The lookup table may be preset by an agreement between the video encoding apparatus and the video decoding apparatus.

As another example, an index may map two blending regions τ₀ and τ₁ in combination. The blending regions mapped to the index may be organized as a lookup table. The lookup table may be preset by an arrangement between the video encoding apparatus and the video decoding apparatus. The video decoding apparatus may parse the one index and may use the index to determine a final blending region of the two regions from the lookup table.

A method of implicitly determining a final blending region based on template matching is described below.

FIG. 16 is a diagram illustrating the determination of a final blending region based on template matching, according to at least one embodiment of the present disclosure.

The video decoding apparatus determines the initial blending region to be a predetermined fixed region based on the current block's size, geometric partitioning mode, and/or color components.

By using the neighboring reconstructed region of the current block, the neighboring template regions of the initial predicted signals P₀ and P₁ of the current block, and the geometric partitioning mode of the current block, the video decoding apparatus extends the geometric split boundary to the neighboring templates of each of the initial predicted signals, as illustrated in FIG. 16. The video decoding apparatus generates candidate blending regions based on the initial blending region. After generating a blending matrix for each candidate blending region, the video decoding apparatus uses the generated blending matrix to weight sum the neighboring templates and thereby generates a candidate template corresponding to each of the candidate blending regions. The video decoding apparatus compares the candidate templates with the template in the reconstructed region of the current block based on a cost function and reorders the candidate templates according to the cost function value. Based on the reordered candidate templates, the video decoding apparatus may determine a candidate blending region corresponding to the candidate template with the least cost to be the final blending region and may use a blending matrix corresponding to the final blending region.

In this case, the size of the template region may be determined based on the size of the current block, or a preset size may be used. In the example of FIG. 16, the size of the template region is determined by the size of the current block, ‘a’ that is the width of the template on the left side of the current block, and ‘b’ that is the height of the template on the top of the current block. Further, for the cost function, a measure may be used, such as Mean Square Errors (MSE), Sum of Absolute Differences (SAD), Sum of Absolute Transformed Differences (SATD), or the like.

In one example, the video decoding apparatus generates the final predicted signals P_{G} of the current block based on the blending matrix W_{B} and the initial predicted signals P₀ and P₁ calculated by the blending region determination process by performing weight summing as shown in Equation 10.

$${P}_{G} ( i , j ) = ( {W}_{B} ( i , j ) \times {P}_{0} + ( {2}^{k} - {W}_{B} ( i , j ) ) \times {P}_{1} + ( {2}^{k - 1} ) ) ≫ k \qquad [ Equation 10 ]$$

The video decoding apparatus then decodes the residual signals and sums the residual signals and the final predicted signals to generate a reconstructed block of the current block.

With a chroma component, the video decoding apparatus generates the final blending region of the chroma block by sampling the final blending region determined in the co-located luma block according to the color format. As another example, for a chroma component, the process described above may be performed to determine a blending region of each subregion centered on a geometric split boundary.

The video decoding apparatus calculates a blending matrix by using the blending regions generated as described above and then uses the blending matrix and the initial predicted signals to generate the final predicted signals of the chroma block.

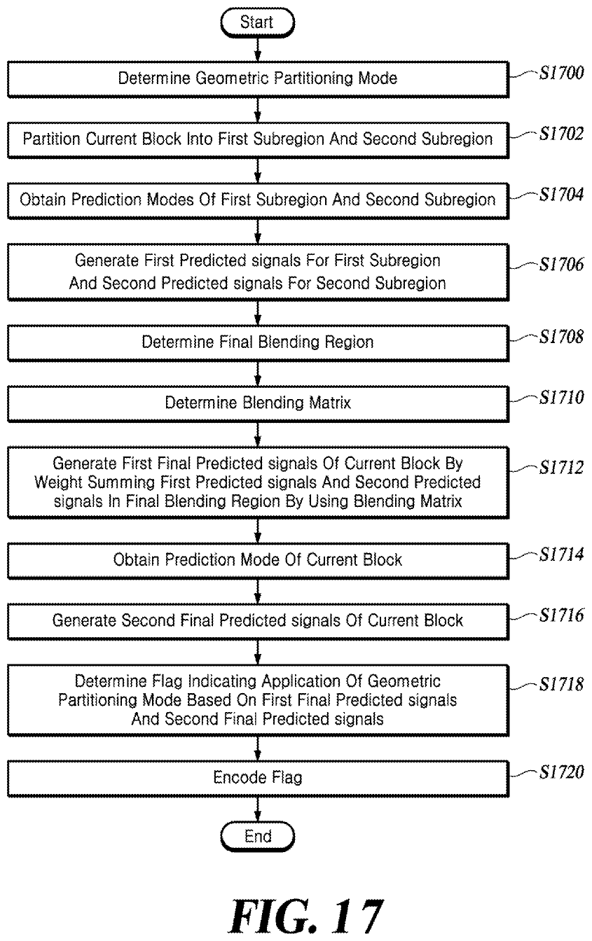

FIG. 17 is a flowchart of a method of encoding a current block by a video encoding apparatus, according to at least one embodiment of the present disclosure.

The video encoding apparatus determines a geometric partitioning mode of the current block (S1700). For example, in terms of rate-distortion optimization, the video encoding apparatus may determine a geometric partitioning mode of the current block.

The video encoding apparatus partitions the current block into a first subregion and a second subregion centered on a geometric split boundary according to the geometric partitioning mode (S1702).

The video encoding apparatus obtains prediction modes of the first subregion and the second subregion (S1704). The prediction modes of the first subregion and the second subregion may be an inter-prediction mode or an intra-prediction mode.

The video encoding apparatus generates the first predicted signals for the first subregion and the second predicted signals for the second subregion according to the prediction modes of the first subregion and the second subregion (S1706).

The video encoding apparatus determines a final blending region for weight summing the first predicted signals and the second predicted signals based on the first predicted signals, the second predicted signals, and an initial blending region (S1708). Here, the initial blending region may be determined based on the current block's size and geometric partitioning mode.

The video encoding apparatus determines a blending matrix in the final blending region (S1710).

The video encoding apparatus generates the first final predicted signals of the current block by weight summing, in the final blending region, the first predicted signals and the second predicted signals by using the blending matrix (S1712).

The video encoding apparatus obtains the prediction mode of the current block (S1714). The prediction mode of the current block may be an inter-prediction mode or an intra-prediction mode.

The video encoding apparatus generates the second final predicted signals of the current block according to the prediction mode (S1716).

The video encoding apparatus determines a flag indicating the application of the geometric partitioning mode based on the first final predicted signals and the second final predicted signals (S1718).

In terms of rate-distortion optimization, the video encoding apparatus may determine the aforementioned flag. For example, when the first final predicted signals are optimal, the video encoding apparatus sets the flag to true. Alternatively, when the second final predicted signals are optimal, the video encoding apparatus sets the flag to false.

The video encoding apparatus encodes the flag (S1720).

Depending on the value of the flag, the video encoding apparatus subtracts the first final predicted signals or the second final predicted signals from the original block of the current block to generate residual signals. The video encoding apparatus then encodes the residual signals.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

120: predictor
540: predictor
602: prediction unit-determiner
604: prediction technique-determiner
606: prediction mode-determiner
608: prediction performer

### CROSS-REFERENCE TO RELATED APPLICATIONS

This application claims priority to and the benefit of Korean Patent Application No. 10-2022-0156601 filed on Nov. 21, 2022, and Korean Patent Application No. 10-2023-0153800, filed on Nov. 8, 2023, the entire contents of each of which are incorporated herein by reference.

1. A method of reconstructing a current block by a video decoding apparatus, the method comprising:
decoding a geometric partitioning mode of the current block;
partitioning the current block into a first subregion and a second subregion centered on a geometric split boundary according to the geometric partitioning mode;
generating first predicted signals for the first subregion and second predicted signals for the second subregion according to prediction modes of the first subregion and the second subregion;
determining a final blending region for weight summing the first predicted signals and the second predicted signals based on the first predicted signals, the second predicted signals, and an initial blending region;
determining a blending matrix in the final blending region; and
generating final predicted signals of the current block by weight summing the first predicted signals and the second predicted signals in the final blending region by using the blending matrix.

2. The method of claim 1, further comprising:
determining the initial blending region based on a size of the current block and the geometric partitioning mode of the current block.

3. The method of claim 1, wherein determining the final blending region comprises:
determining whether or not the geometric split boundary is a strong edge by comparing sample values of the first initial predicted signals and the second initial predicted signals located at the geometric split boundary; and
checking whether the geometric split boundary is the strong edge.

4. The method of claim 3, wherein determining the final blending region comprises, when the geometric split boundary is not the strong edge:
secondly determining whether the geometric split boundary is the strong edge by comparing sample values of the first initial predicted signals and the second initial predicted signals located at a first inner boundary that is located in the first subregion.

5. The method of claim 4, wherein determining the final blending region comprises, when the geometric split boundary is not the strong edge:
thirdly determining whether the geometric split boundary is the strong edge by comparing sample values of the first initial predicted signals and the second initial predicted signals located at a second inner boundary that is located in the second subregion.

6. The method of claim 4, further comprising:
checking whether a secondly determined geometric split boundary is the strong edge,
wherein determining the final blending region further comprises, when the secondly determined geometric split boundary is the strong edge:
setting a size of a blending region of the first subregion to 0.

7. The method of claim 4, further comprising:
checking whether a secondly determined geometric split boundary is the strong edge,
wherein determining the final blending region further comprises, when the secondly determined geometric split boundary is not the strong edge:
determining the final blending region by comparing sample values of the first initial predicted signals and the second initial predicted signals that are located in the first subregion and distanced by blending candidate region from the geometric split boundary.

8. The method of claim 5, further comprising:
checking whether a thirdly determined geometric split boundary is the strong edge,
wherein determining the final blending region further comprises, when the thirdly determined geometric split boundary is the strong edge:
setting a size of a blending region of the second subregion to 0.

9. The method of claim 3, wherein determining the final blending region further comprises, when the geometric split boundary is the strong edge:
calculating a slope by using sample values of the first initial predicted signals and the second initial predicted signals within the initial blending region.

10. The method of claim 10, wherein determining the final blending region further comprises:
calculating a strength of the geometric split boundary based on the slope; and
determining whether the geometric split boundary is a strong edge by using the strength of the geometric split boundary.

11. The method of claim 1, wherein determining the blending matrix is characterized in that each weight in the blending matrix has an integer value from 0 to 2^{k}, wherein k is an integer value equal to or greater than 0.

12. The method of claim 1, wherein determining the blending matrix comprises:
organizing the blending matrix to include weights that incrementally increase and decrease around the geometric split boundary.

13. A method of encoding a current block by a video encoding apparatus, the method comprising:
determining a geometric partitioning mode of the current block;
partitioning the current block into a first subregion and a second subregion centered on a geometric split boundary according to the geometric partitioning mode;
generating first predicted signals for the first subregion and second predicted signals for the second subregion according to prediction modes of the first subregion and the second subregion;
determining a final blending region for weight summing the first predicted signals and the second predicted signals based on the first predicted signals, the second predicted signals, and an initial blending region;
determining a blending matrix in the final blending region; and
generating first final predicted signals of the current block by weight summing the first predicted signals and the second predicted signals in the final blending region by using the blending matrix.

14. The method of claim 13, further comprising:
obtaining a prediction mode of the current block; and
generating second final predicted signals of the current block based on the prediction mode.

15. The method of claim 14, further comprising:
determining a flag indicating an application of the geometric partitioning mode based on the first final predicted signals and the second final predicted signals; and
encoding the flag.

16. The method of claim 13, further comprising:
obtaining the prediction modes of the first subregion and the second subregion; and
determining the initial blending region based on a size of the current block and the geometric partitioning mode of the current block.

17. A computer-readable recording medium storing a bitstream generated by a video encoding method, the video encoding method comprises:
determining a geometric partitioning mode of a current block;
partitioning the current block into a first subregion and a second subregion centered on a geometric split boundary according to the geometric partitioning mode;
generating first predicted signals for the first subregion and second predicted signals for the second subregion according to prediction modes of the first subregion and the second subregion;
determining a final blending region for weight summing the first predicted signals and the second predicted signals based on the first predicted signals, the second predicted signals, and an initial blending region;
determining a blending matrix in the final blending region; and
generating final predicted signals of the current block by weight summing the first predicted signals and the second predicted signals in the final blending region by using the blending matrix.
